(19) United States
(12) Patent Application Publication
(10) Pub. No.: US 2008/0083780 A1
(43) Pub. Date: Apr. 10, 2008

(54) Methods and apparatus for dispensing

(75) Inventors: Michael T. Romanyszyn, San Antonio, TX (US); Basil F. Girjis, San Antonio, TX (US)

Correspondence Address: Dennis Braswell;Braswell & Associates, P.C., 105 Soost Court, Mobile, AL, 36608, US

(73) Assignee: Lancer Partnership, Ltd.

(21) Appl. No.: 11/545,196

(22) Filed: Oct. 10, 2006

(51) Int. Cl. B67D 5/56

(52) U.S. Cl. 222/129.1; 222/325

(57) ABSTRACT

Methods and apparatus for mixing are provided in which a dispenser (10) is used to dispense liquid from a disposable package (12) that is combined with a disposable mixer (14) and a tube (18). The mixer (14) includes tamper evident seals (60 and 62) over its mixing fluid inlet (50) and discharge outlet (54). These tamper evident seals (60 and 62) are removed before dispensing.

### TECHNICAL FIELD OF THE INVENTION

This invention relates generally to dispensing, and in particular to methods and apparatus for dispensing mixed liquids.

### BACKGROUND OF THE INVENTION

Many dispensers exist for dispensing liquids. Some dispensers mix one liquid, such as, without limitation, a juice concentrate or a syrup, with another, such as water, to form a finished product. The juice or syrup are often stored in a disposable package.

It is desirable to make it easier, more sanitary, or more cost effective to change out the disposable package than presently available.

### SUMMARY OF THE INVENTION

In accordance with the teachings of the present invention, methods and apparatus for mixing are provided which eliminate or substantially reduce the problems associated with prior art systems.

In one aspect of the present invention, a package and mixing apparatus combination is provide that includes a compartment holding a liquid, a tube coupled to the compartment, a mixer coupled to the tube, the mixer comprising a mixing fluid inlet and a mixed fluid outlet, a mixing fluid inlet tamper evident seal coupled to the mixing fluid inlet, and a mixed fluid outlet tamper evident seal coupled to the mixed fluid outlet.

In particular embodiments, the combination further includes a self-sealing dispensing valve coupled to the tube between the compartment and the mixer. The self-sealing dispensing valve and the tube may comprise an integrated unit. Also, a fitting may be coupled to the tube which surrounds the self-sealing dispensing valve. The fitting may carry the self-sealing dispensing valve. Also, a retaining ring may be used to retain the self-sealing dispensing valve in the fitting.

Also in particular embodiments, the compartment may comprise a flexible package having a bottom portion and a front portion, with the tube coupled to the bottom portion of the package near the front portion of the package. Also, the container, tube, and mixing chamber may be disposable.

Also provided is a system for dispensing that includes a housing, a pump, and a package and mixing apparatus adapted to be coupled to the pump. The package and mixing apparatus include a container holding liquid to be dispensed, a tube coupled to the container, a mixer coupled to the tube, the mixer comprising a mixing fluid inlet and a mixed fluid outlet, a mixing fluid inlet tamper evident seal coupled to the mixing fluid inlet, and a mixed fluid outlet tamper evident seal coupled to the mixed fluid outlet.

In particular embodiments of the system, the pump is a peristaltic pump. Also, the system may include a cold source and a first water line passing through the cold source and adapted to be coupled to the mixing fluid inlet of the mixer after the mixing fluid tamper evident seal is removed from the mixing fluid inlet. In particular embodiments, the first water line may be coupled to a source of carbonated water or to a source of plain water. Also, a first water valve may be provided that is coupled to the first water line upstream of the cold source, the first water valve being operable to open in response to a dispense request.

The system may also include a second water line passing through the cold source and adapted to be coupled to the mixing fluid inlet of the mixer, wherein first water line is coupled to a source of carbonated water and the second water line is coupled to a source of plain water, such that the liquid may be mixed with either carbonated water or plain water. Also, a first water valve may be provided that is coupled to the first water line upstream of the cold source and a second water valve coupled to the second water line upstream of the cold source, the first and second water valves being respectively operable to open in response to a respective dispense request for carbonated water or plain water dispensing. In particular embodiments, the cold source may be ice/water bath or a cold plate.

Also, a mixer is provided that includes a mixing chamber, a first fluid inlet in communication with the mixing chamber, a second fluid inlet in communication with the mixing chamber, a mixed fluid outlet in communication with the mixing chamber, a mixing fluid inlet tamper evident seal coupled to the second fluid inlet, and a mixed fluid outlet tamper evident seal coupled to the mixed fluid outlet.

Important technical advantages are provided herein, including, without limitation, the provision of a disposable unit that includes a package, tube, and mixer, with tamper evident seals over the mixer outlet and mixing fluid inlet. Another important technical advantage of the present invention is the inclusion of a self-sealing dispensing valve between the tube and mixer.

### BRIEF DESCRIPTION OF THE DRAWINGS

Reference is made in the description to the following briefly described drawings, wherein like reference numerals refer to corresponding elements:

FIG. 1 is a schematic illustration of one embodiment of a dispenser according to one aspect of the present invention;

FIG. 2 illustrates a perspective view of one embodiment of a combined package, tube, and mixer according to one aspect of the present invention;

FIG. 3 illustrates a sectional view of the combination shown in FIG. 2; and

FIG. 4 illustrates an exploded view of the combination shown in FIG. 2.

### DETAILED DESCRIPTION OF THE INVENTION

The following describes various aspects of the present invention, which may stand alone or be combined. A dispensing system 10 is first described, which includes a disposable package 12 for a liquid to be dispensed. Also described is a disposable mixer 14 used to mix the liquid with a mixing fluid, such as plain or carbonated water. Also, a disposable tube 18 is described that includes a device for effectively preventing dripping problems. In operation, when the package 12 is effectively empty, the package 12, mixer 14, and tube 18 are discarded and replaced.

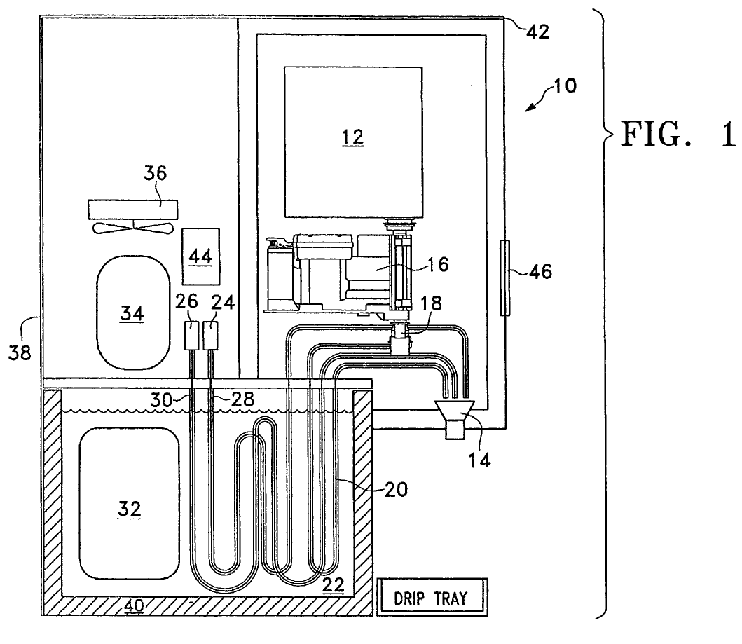

FIG. 1 illustrates one embodiment of the dispenser 10, wherein the package 12, mixer 14, and tube 18 are installed for use. In the particular example illustrated, the liquid in package 12 is a drink concentrate, such as a soft drink syrup, a juice concentrate, or a milk concentrate (although any suitable liquid may be used). The liquid is to be mixed with plain or carbonated water to form a finished drink in the mixer 14. Mixer 14 receives the liquid from the package 12, as well as the plain or carbonated water, and mixes them to form the finished drink. The finished drink is dispensed through a dispensing point into any suitable receptacle, such as a cup (not shown).

A pump 16 pumps the liquid from the package 12 toward mixer 14. The liquid is pumped through the tube 18, which is coupled to the package 12 directly or through a fitment 13 or any suitable coupling approach. Although a canoe-shaped fitment is shown, any other suitable shape may be used. Tube 18 is also coupled directly or indirectly to the mixer 14.

Also shown in FIG. 1 are water valve 24 and soda valve 26. These valves are used to control the flow of plain or carbonated water to the mixer 14. The plain or carbonated water is mixed with the liquid from the package 12 to form finished drinks. Water from the valves 24 or 26 may be coupled directly to the mixer 14, or passed through lines 28 and 30 (respectively), which pass through the ice/water bath 20. Lines 28 and 30 may take circuitous paths through the ice/water bath 20, such as, without limitation, coiled paths. Valves 24 and 26 may be located upstream of the ice/water bath 20, as shown in FIG. 1, or elsewhere, for example, between the ice/water bath 20 and the nozzle 14. Valves 24 and 26 may be any suitable valve, including, without limitation, on/off solenoid valves, flow control valves, or volumetric valves. Mixer 14 may include separate inlets for the plain and carbonated water, or a selector may be provided to select (manually or electrically or otherwise) the appropriate one of the plain or carbonated water for inlet to a single mixing fluid inlet of the mixer 14.

The ice/water bath 22 may be formed by creating an ice bank 32 by freezing water around an evaporator of a conventional refrigeration system. A compressor 34 and condenser 36 of such a system are shown schematically in FIG. 1. The dispenser 10 is generally structured with a housing 38, and includes an insulated chamber 40 for holding the ice/water bath 20. A cover 42 may be used to cover the top of the dispenser 10. Also, the package 12 and pump 16 may reside in an insulated compartment that is refrigerated by the refrigeration system. Access to the package 12 and pump 16 is provided through a door in the front, side, or back of the dispenser. Although an ice/water bath 20 is shown in FIG. 1, any other suitable cooling source may be used to cool the liquid or water to be dispensed. For example, a metal cold plate could be used, wherein one or more conduits are cast into the cold plate and coupled to one or more of the lines 20, 28, and 30. With a cold plate as the cold source, ice is placed on the cold plate, causing the cold plate to cool the liquid or water passing through it. Also, the pump 16 may be located outside of the dispenser 10. The package 12 may also be located outside the dispenser 10, or within an un-refrigerated compartment of dispenser 10. Furthermore, if desired, rather than (or in addition to) a cooling system, a heating system may be used to heat a liquid to be dispensed, for example, and without limitation, for soups or cheeses. For liquids to be heated, the package 12 or pump 16 may be heated.

A controller 44, which may comprise, without limitation, a microcontroller or microprocessor based control system, is used to control operation of the dispenser 10. The controller 44 is coupled to the valves 24 and 26, the pump 16, the refrigeration system, and to a user interface 46. User interface 46 may be one or more switches or other input devices used to receive requests for dispenses. For example, if a carbonated beverage is requested, controller 44 controls soda valve 26 and pump 16 to dispense the proper amounts of liquid from package 12 and soda water to form the finished drink. Controller 44 may also receive inputs related to options for mixing and ratio accuracies, among other control functions. These inputs may be provided through user interface 46 or any other suitable interface (such as, without limitation, from a hand-held electronic device).

The soda (carbonated water) may be generated at a remote carbonator, or in a carbonator located within the dispenser 10. Also, the carbonator could be located within the ice/water bath 22 or other cold source.

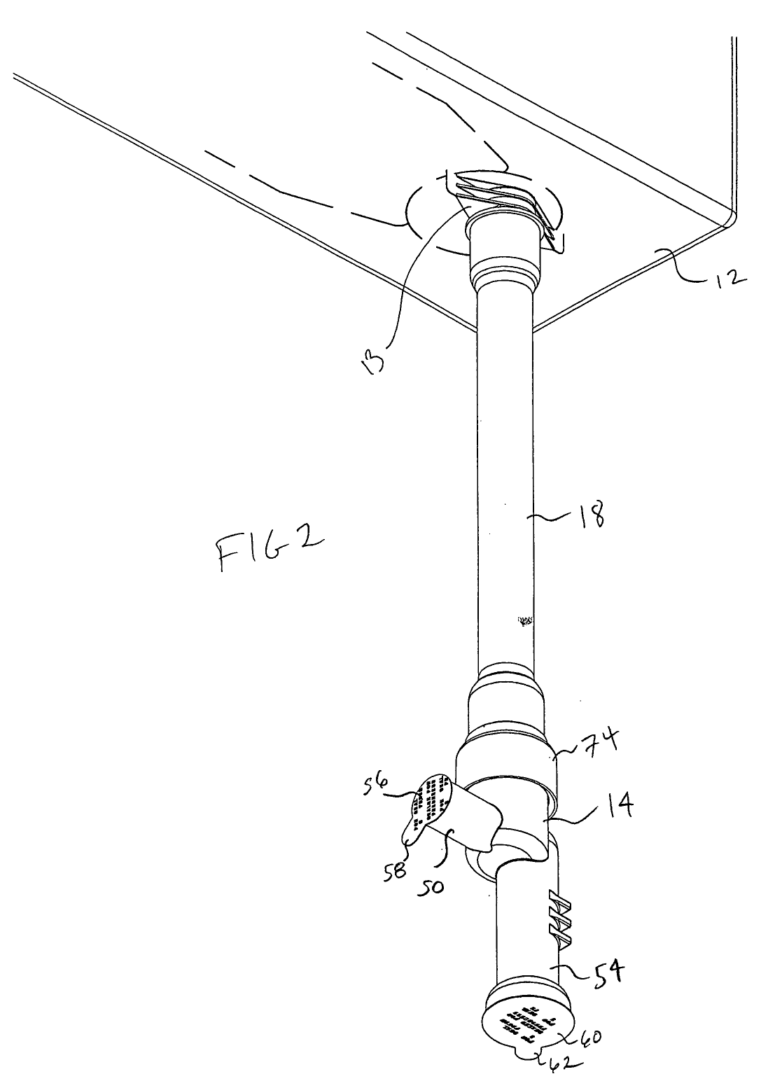

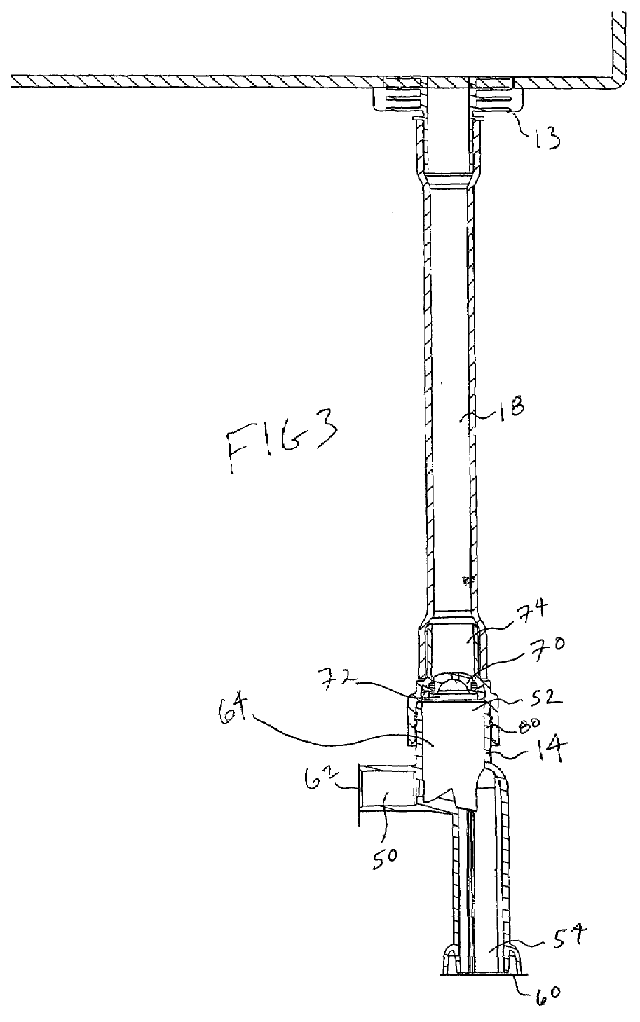

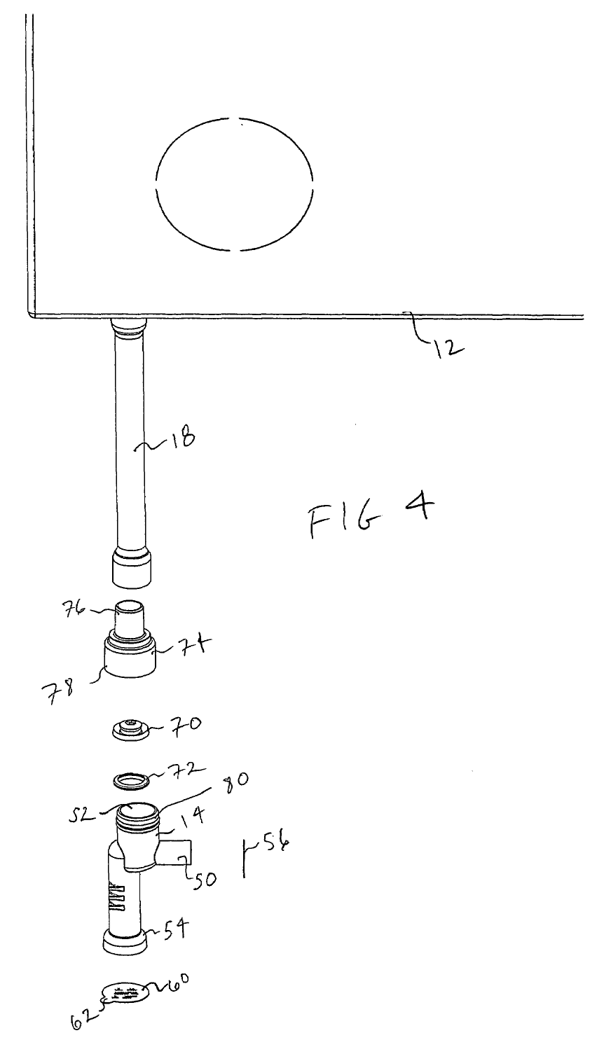

FIGS. 2, 3 and 4 illustrate a particular embodiment of the package 12, mixer 14, and tube 18. FIG. 2 is illustrates the coupled combination of the package 12, mixer 14, and tube 18. FIG. 3 is a sectional illustration of the same combination, and FIG. 4 is an exploded view of the combination.

As shown, mixer 14 includes a mixing fluid inlet 50, a liquid inlet 52, and a mixed fluid outlet 54. Mixing fluid inlet 50 is covered by a tamper evident seal 56, which may include a tab 58 for facilitating easy removal. Similarly, outlet 54 covered by a tamper evident seal 60, which may include a tab 62 for facilitating easy removal before dispensing. Tabs 58 and 62 are examples only, and may be omitted, or any other device may be used to facilitate easy removal of the tamper evident seals 56 and 60. In operation, the tamper evident seals 56 and 60 are removed, and the inlet 50 is coupled to the mixing fluid of the dispenser 10, for example, line 28 or line 30 of FIG. 1, or to a selector that selects the appropriate mixing fluid. Outlet 54 discharges the liquid from the package 12 and the mixing fluid, directly or indirectly, into a receptacle, such as a cup.

Mixer 14 is shown with only one mixing fluid inlet 50. However, it should be understood that this is an example only, and more than one such inlets may be provided (for example, and without limitation, one for carbonated water and one for plain water). Each of any such multiple inlets is covered with a tamper evident seal.

The mixer 14 preferably includes a mixing chamber 64 in which the liquid from package 12 is mixed with plain or carbonated water. However, mixer 14 may be any suitable device that facilitates formation of a finished drink. For example, and without limitation, mixer 14 may be a nozzle that receives the liquid and the water, and keeps them separate until they are discharged from the nozzle for mixing in air or in the receptacle into which they are dispensed. Furthermore, the outlet 54 of the mixer 14 may discharge directly into the receptacle (e.g., a cup), or into a nozzle or other intermediate device.

The package 12, the mixer 14, and the tube 18 are preferably coupled together and shipped to the customer for use in this combined arrangement. The tamper evident seals 56 and 60 provide the security of tamper evidence.

The mixer 14 may be, without limitation, a mixer such as that described in U.S. patent application Ser. No. 10/869,122, filed Jun. 16, 2004, and entitled “METHOD AND APPARATUS FOR A MIXING ASSEMBLY,” which is herein incorporated by reference in its entirety.

Another aspect of the present invention involves the prevention of leaking from the tube 18 during storage, use, or replacement of spent packages 12. When the liquid in package 12 is depleted, the package must be removed and replaced with a new package 12. Unfortunately, during this process, liquid remnant in the spent package and tube often leaks out of the tube. Also, when loading a new package, dripping can occur. Prior art attempts to address this dripping problem (other than in the above-referenced, commonly assigned U.S. patent application Ser. No. 11/085,370) involve the use of manually operated check valves at the end of the tube. These are unsatisfactory, however, because of their cost, and because the users often forget to open them, causing pump failures or significant messes, or do not understand to close them, rendering them useless against the dripping problem they were intended to solve. Moreover, it is important to prevent dripping even after a package is installed, for example when a dispenser is idle.

To address the dripping problem, one aspect of the present invention involves coupling a self-sealing dispensing valve to the tube 18. The self-sealing dispensing valve may be any suitable self-sealing dispensing valve, but in a particular embodiment is a valve such as those disclosed in U.S. Pat. No. 5,213,236, issued on May 25, 1993 to Brown et al., and entitled “DISPENSING VALVE FOR PACKAGING.” That patent is herein incorporated, in its entirety, by reference. Such a self-sealing dispensing valve allows liquid to be dispensed during pumping operations without restricting flow, because it has a relatively low opening pressure and negligible pressure drop across the valve. And, once pumping ceases, the self-sealing dispensing valve automatically seals, thus providing a relatively sharp cut-off and preventing leaking and dripping, both while the package 12 and tube 18 are installed in the dispenser and while they are being removed and loaded into the dispenser, without the need for any action by the user. The self-sealing dispensing valve may be formed from a resiliently flexible material, and in particular may be formed from a silicone rubber that is substantially inert. For illustration only, and without limitation, in one example the tube inside diameter is about 10 millimeters, and the self-sealing dispensing valve should be able to seal against an internal pressure of about 75 pounds per square inch in a 2.5 gallon flexible bag of liquid. Particular approaches, without limitation, for coupling the self-sealing dispensing valve to tube 18 are provided in U.S. patent application Ser. No. 11/085,370, filed Mar. 21, 2005, and entitled “METHODS AND APPARATUS FOR PUMPING AND DISPENSING,” which, as mentioned above, is herein incorporated by reference in its entirety.

FIGS. 3 and 4 illustrate one particular approach for using a self-sealing dispensing valve as part of the present invention. As shown in these FIGUREs, a self-sealing dispensing valve 70 is held by a retaining ring 72 within a fitment 74. Fitment 74 includes an upstream end 76 for coupling to tube 18, and a downstream end 78 for coupling to mixer 14. In the particular example shown, upstream end 76 has a narrower inside diameter than downstream end 78. To facilitate coupling between the mixer 14 and the fitment 74, for example and without limitation, ribs 80 may be provided on the mixer 14 (with complimentary ribs on the inside of fitment 74), for a snap fit of the fitment 74 over the mixer 14. Threads or any other suitable approach for facilitating coupling may also be used. The tube 18 may be coupled to the fitment 74 by any suitable approach, for example, and without limitation, by stretching it over upstream end 76.

Although it is preferable to include the self-sealing dispensing valve, it may be omitted. In such case, the fitment 74 may be used to couple the tube 18 to the mixer 14, or the tube 18 may be coupled to the mixer 14 in any other suitable approach. For example, and without limitation, the tube 18 may be stretched over inlet 52, which may be sized to accommodate such coupling.

Although the dispenser 10 shown in FIG. 1 is particularly suited for the dispensing of juice, milk, or other soft drinks, such applications are examples only. The teachings herein apply as well to the dispensing or pumping of any suitable liquid or semi-liquid (either being referred to herein as a “liquid”), including, without limitation, concentrates, syrups, beverages, milks, cheeses, condiments, soups, sauces, pharmaceuticals, and other edible or drinkable products.

The package 12 may be located within the dispenser 10, as shown in FIG. 1, or it may be located outside the dispenser 10. Furthermore, although one liquid package 12 is shown, a plurality of liquid packages may be used for dispensing a plurality of finished drinks. With such a plurality of packages 12, a plurality of pumps 16 would also be used. Package 12 may be a flexible package, such as, without limitation, a plastic pouch, with or without an outer housing such as a cardboard box. Alternatively, and without limitation, package 12 may be a molded or extruded plastic package. Also, although plain and carbonated water circuits are shown, only one or the other could be used, and, indeed, none would be needed if the liquid is at a ready-to-dispense strength.

The pump 16 may be a peristaltic pump such as that described in U.S. patent application Ser. No. 11/085,370, filed Mar. 21, 2005, and entitled “METHODS AND APPARATUS FOR PUMPING AND DISPENSING,” which is herein incorporated by reference in its entirety.

Furthermore, provision may be made for dispensing additional flavorings, such as, without limitation, cherry or vanilla. Such flavors are often referred to as “bonus flavors,” and, without limitation, may be coupled directly to the mixer 14, for example through an additional inlet, or may be discharged into the receptacle in parallel with the discharge 54 of mixer 14.

Within this description, coupling includes both direct coupling of elements, and coupling indirectly through intermediate elements.

The particular embodiments and descriptions provided herein are illustrative examples only, and features and advantages of each example may be interchanged with, or added to the features and advantages in the other embodiments and examples herein. Moreover, as examples, they are meant to be without limitation as to other possible embodiments, are not meant to limit the scope of the present invention to any particular described detail, and the scope of the invention is meant to be broader than any example. Also, the present invention has several aspects, as described above, and they may stand alone, or be combined with some or all of the other aspects.

And, in general, although the present invention has been described in detail, it should be understood that various changes, alterations, substitutions, additions and modifications can be made without departing from the intended scope of the invention, as defined in the following claims.

What is claimed is:

1. A package and mixing apparatus combination, comprising:
a compartment holding a liquid;
a tube coupled to the compartment;
a mixer coupled to the tube, the mixer comprising a mixing fluid inlet and a mixed fluid outlet;
a mixing fluid inlet tamper evident seal coupled to the mixing fluid inlet; and
a mixed fluid outlet tamper evident seal coupled to the mixed fluid outlet.

2. The apparatus of claim 1, and further comprising a self-sealing dispensing valve coupled to the tube between the compartment and the mixer.

3. The apparatus of claim 2, wherein the self-sealing dispensing valve and the tube comprise an integrated unit.

4. The apparatus of claim 2, and further comprising a fitting coupled to the tube and surrounding the self-sealing dispensing valve.

5. The apparatus of claim 2, and further comprising a fitting coupled to the tube, the fitting carrying the self-sealing dispensing valve.

6. The apparatus of claim 5 and further comprising a retaining ring coupled to the fitting operable to retain the self-sealing dispensing valve in the fitting.

7. The apparatus of claim 1, wherein the compartment comprises a flexible package having a bottom portion and a front portion, and wherein the tube is coupled to the bottom portion of the package near the front portion of the package.

8. The apparatus of claim 1, wherein the container, tube, and mixing chamber are disposable.

9. A system for dispensing, comprising:
a housing;
a pump; and
a package and mixing apparatus adapted to be coupled to the pump, comprising:
a container holding liquid to be dispensed;
a tube coupled to the container;
a mixer coupled to the tube, the mixer comprising a mixing fluid inlet and a mixed fluid outlet;
a mixing fluid inlet tamper evident seal coupled to the mixing fluid inlet;
and
a mixed fluid outlet tamper evident seal coupled to the mixed fluid outlet.

10. The system of claim 9, wherein the pump is a peristaltic pump.

11. The system of claim 9, and further comprising:
a cold source; and
a first water line passing through the cold source and adapted to be coupled to the mixing fluid inlet of the mixer after the mixing fluid tamper evident seal is removed from the mixing fluid inlet.

12. The system of claim 11, wherein the first water line is coupled to a source of carbonated water.

13. The system of claim 11, wherein the first water line is coupled to a source of plain water.

14. The system of claim 11, and further comprising a first water valve coupled to the first water line upstream of the cold source, the first water valve being operable to open in response to a dispense request.

15. The system of claim 1 1, and further comprising a second water line passing through the cold source and adapted to be coupled to the mixing fluid inlet of the mixer, wherein first water line is coupled to a source of carbonated water and the second water line is coupled to a source of plain water, such that the liquid may be mixed with either carbonated water or plain water.

16. The system of claim 15, and further comprising a first water valve coupled to the first water line upstream of the cold source and a second water valve coupled to the second water line upstream of the cold source, the first and second water valves being respectively operable to open in response to a respective dispense request for carbonated water or plain water dispensing.

17. The system of claim 11, wherein the cold source is an ice/water bath.

18. The system of claim 11, wherein the cold source is a cold plate.

19. A mixer, comprising:
a mixing chamber;
a first fluid inlet in communication with the mixing chamber;
a second fluid inlet in communication with the mixing chamber;
a mixed fluid outlet in communication with the mixing chamber;
a mixing fluid inlet tamper evident seal coupled to the second fluid inlet; and
a mixed fluid outlet tamper evident seal coupled to the mixed fluid outlet.
